(19) United States
(12) Patent Application Publication
(10) Pub. No.: US 2022/0312225 A1
(43) Pub. Date: Sep. 29, 2022

(54) COMMUNICATION METHOD, AND USER EQUIPMENT AND NETWORK EQUIPMENT PERFORMING THE COMMUNICATION METHOD

(71) Applicant: Samsung Electronics Co., Ltd., Gyeonggi-do (KR)

(72) Inventors: Bozhi LI, Beijing (CN); He WANG, Beijing (CN); Haijie QIU, Beijing (CN)

(21) Appl. No.: 17/619,134

(22) PCT Filed: Aug. 14, 2020
(86) PCT No.: PCT/KR2020/010866

§ 371 Date: Dec. 14, 2021

(30) Foreign Application Priority Data
Aug. 14, 2019 (CN) 201910748745.9
Feb. 13, 2020 (CN) 202010095070.5

(51) Int. Cl. H04W 16/28; H04W 24/10; H04W 72/12; H04L 5/00; H04W 52/14; H04W 52/36; H04B 7/06

(52) U.S. Cl. CPC H04W 16/28; H04W 24/10; H04W 72/1263; H04L 5/0051; H04W 52/143; H04W 52/367; H04B 7/0695

(57) ABSTRACT

Provided is a communication method, and a user equipment and a network equipment performing the communication method, communication method performed by a user equipment, comprising: measuring downlink signals; determining a downlink receiving beam and a first uplink transmitting beam according to a measurement result for the downlink signals; generating indication information for beam correspondence according to the measurement result for the downlink signals and/or preset user equipment information, and sending, to a network equipment, the generated indication information for beam correspondence with the determined first uplink transmitting beam; performing uplink transmitting beam sweeping according to a resource for performing uplink transmitting beam sweeping allocated by the network equipment, when an indication to enable uplink transmitting beam sweeping of the user equipment sent by the network equipment is received; receiving, with the determined downlink receiving beam, the measurement result of the uplink transmitting beam sweeping fed back by the network equipment, and determining a second uplink transmitting beam according to the measurement result of the uplink transmitting beam sweeping; transmitting an uplink signal with the determined second uplink transmitting beam.

### TECHNICAL FIELD

The present disclosure relates to a field of wireless communication technique, and more particularly, to a communication method, and a user equipment and a network equipment performing the communication method.

### BACKGROUND ART

To meet the demand for wireless data traffic having increased since deployment of 4th generation (4G) communication systems, efforts have been made to develop an improved 5th generation (5G) or pre-5G communication system. The 5G or pre-5G communication system is also called a ‘beyond 4G network’ or a ‘post long term evolution (LTE) system’. The 5G communication system is considered to be implemented in higher frequency (mmWave) bands, e.g., 60 GHz bands, so as to accomplish higher data rates. To decrease propagation loss of the radio waves and increase the transmission distance, beamforming, massive multiple-input multiple-output (MIMO), full dimensional MIMO (FD-MIMO), array antenna, analog beamforming, and large scale antenna techniques are discussed with respect to 5G communication systems. In addition, in 5G communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancellation and the like. In the 5G system, hybrid frequency shift keying (FSK) and Feher's quadrature amplitude modulation (FQAM) and sliding window superposition coding (SWSC) as an advanced coding modulation (ACM), and filter bank multi carrier (FBMC), non-orthogonal multiple access (NOMA), and sparse code multiple access (SCMA) as an advanced access technology have been developed.

The Internet, which is a human centered connectivity network where humans generate and consume information, is now evolving to the Internet of things (IoT) where distributed entities, such as things, exchange and process information without human intervention. The Internet of everything (IoE), which is a combination of the IoT technology and the big data processing technology through connection with a cloud server, has emerged. As technology elements, such as As technonologyed connectivity network where humans generate and consume information, is now evolving to the Internet of things (IoT) where ud server, has emeIoT implementation, a sensor network, a machine-to-machine (M2M) communication, machine type communication (MTC), and so forth have been recently researched. Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing information technology (IT) and various industrial applications.

In line with this, various attempts have been made to apply 5G communication systems to IoT networks. For example, technologies such as a sensor network, MTC, and M2M communication may be implemented by beamforming, MIMO, and array antennas. Application of a cloud RAN as the above-described big data processing technology may also be considered to be as an example of convergence between the 5G technology and the IoT technology.

As described above, various services can be provided according to the development of a wireless communication system, and thus a method for easily providing such services is required.

### DISCLOSURE OF INVENTION

### Solution to Problem

An exemplary embodiment of the present disclosure is to provide a communication method, and a user equipment and a network equipment performing the communication method, which optimize beam management and beam correspondence performance and use uplink beam sweeping reasonably and effectively, and ensure that the user equipment reports appropriate adaptive information to the network equipment, so that the network equipment can reasonably determine whether the uplink transmitting beam sweeping of the user equipment needs to be enabled. If it needs to be enabled, the network equipment will allocate appropriate adaptive resources to the user equipment according to the information reported by the user equipment, thereby improving the beam management and beam correspondence performance in communication.

### BRIEF DESCRIPTION OF DRAWINGS

The above and other objects and features of the exemplary embodiments of the present disclosure will become more apparent from the following description taken in conjunction with the accompanying drawings that exemplarily illustrates embodiments, in which:

FIG. 1 illustrates a schematic flowchart of a method for implementing beam management and beam correspondence in the prior art;

FIG. 2A illustrates a flowchart of a communication method according to one exemplary embodiment of the present disclosure;

FIG. 2B illustrates a schematic diagram of marking a spatial mapping relationship between a transmitting beam and an expected gain of an uplink beam sweeping by a beam correspondence tolerance calibration test for the user equipment according to an exemplary embodiment of the present disclosure;

FIG. 3 illustrates a flowchart of a communication method according to another exemplary embodiment of the present disclosure;

FIG. 4 illustrates a block diagram of a user equipment according to an exemplary embodiment of the present disclosure;

FIG. 5 illustrates a block diagram of a network equipment according to an exemplary embodiment of the present disclosure;

FIG. 6 illustrates a schematic diagram of a communication equipment according to an exemplary embodiment of the present disclosure;

FIG. 7 illustrates a schematic diagram of a communication flow of a communication system including a user equipment and a network equipment according to an exemplary embodiment of the present disclosure;

FIG. 8 illustrates a block diagram of a user equipment according to an exemplary embodiment of the present disclosure; and

FIG. 9 illustrates a block diagram of a network equipment according to an exemplary embodiment of the present disclosure;

### BEST MODE FOR CARRYING OUT THE INVENTION

According to an exemplary embodiment of the present disclosure, there is provided a communication method performed by a user equipment, comprising: measuring downlink signals; determining a downlink receiving beam and a first uplink transmitting beam according to a measurement result for the downlink signals; generating indication information for beam correspondence according to the measurement result for the downlink signals and/or preset user equipment information, and sending, to a network equipment, the generated indication information for beam correspondence with the determined first uplink transmitting beam; performing uplink transmitting beam sweeping according to a resource for performing uplink transmitting beam sweeping allocated by the network equipment, when an indication to enable uplink transmitting beam sweeping of the user equipment sent by the network equipment is received; receiving, with the determined downlink receiving beam, the measurement result of the uplink transmitting beam sweeping fed back by the network equipment, and determining a second uplink transmitting beam according to the measurement result of the uplink transmitting beam sweeping; transmitting an uplink signal with the determined second uplink transmitting beam.

Alternatively, the measured downlink signals may comprise at least one of a Synchronization Signal and PBCH block and a Channel-State Information Reference Signal, and the measurement result for the downlink signals comprises at least one of a Reference Signal Receiving Power (RSRP), a Reference Signal Receiving Quality (RSRQ) and a Signal-to-Noise Ratio (SNR/SINR) of the downlink signals. The measurement result for the downlink signals may be a measurement result for a physical layer or a network layer. Wherein the generating indication information for beam correspondence according to the measurement result for the downlink signals and/or the preset user equipment information may comprise: generating indication information for beam correspondence according to the Reference Signal Receiving Power and/or the Reference Signal Receiving Quality and/or the Signal-to-Noise Ratio in a current measurement result.

Alternatively, the determining the downlink receiving beam and the first uplink transmitting beam according to the measurement result for the downlink signals may comprise: selecting a beam with the highest RSRP measurement value of the downlink signals as the downlink receiving beam; determining a beam corresponding to the downlink receiving beam by the beam correspondence as the first uplink transmitting beam.

Alternatively, the user equipment information may comprise at least one of a current receiving beam index, a current transmitting beam index, other auxiliary information of a current receiving/transmitting beam, and antenna array information of the user equipment.

Alternatively, the generating indication information for beam correspondence may comprise: generating indication information for beam correspondence according to the current transmitting beam index and a mapping table, wherein the mapping table comprises a mapping relationship between transmitting beam indexes and beam correspondence tolerances.

Alternatively, the communication method may further comprise generating the mapping table by a calibration test.

Alternatively, the generating the mapping table may comprise: measuring the power of the second transmitting beam and the power of the first transmitting beam separately, calculating the difference between the power of the second transmitting beam and the power of the first transmitting beam as a beam correspondence tolerance, and recording the first transmitting beam index as the transmitting beam index, for each space test point of the user equipment; performing the same calibration test by traversing through all the space test points, to obtain a beam correspondence tolerance of each transmitting beam index, and generating the mapping table according to the beam correspondence tolerance of each transmitting beam index.

Alternatively, the generating indication information for beam correspondence according to the current transmitting beam index and the mapping table may further comprise: using a maximum value of the beam correspondence tolerance as the beam correspondence tolerance of the transmitting beam index, when the same transmitting beam index is mapped to multiple beam correspondence tolerances.

Alternatively, the indication information for beam correspondence may comprise at least one of one or more binary indication information indicating true or false, one or more decibel data information representing gain, one or more quantity information representing the number of sweeping beams, and one or more data representing the measurement result for the Reference Signal Receiving Power (RSRP), the Reference Signal Receiving Quality (RSRQ), and the Signal-to-Noise Ratio (SNR/SINR) of the downlink signals.

Alternatively, the indication information for beam correspondence may be transmitted to the network equipment by a signaling in which the user equipment reports the measurement result for the Reference Signal Receiving Power (RSRP), the Reference Signal Receiving Quality (RSRQ), and the Signal-to-Noise Ratio (SNR/SINR) of the downlink signals.

Alternatively, the indication information for beam correspondence may be used as a basis for the network equipment to adjust the powers of the downlink signals, and is transmitted to the network equipment for more than once until the power adjustment of the downlink signals is completed by the network equipment. Preferably, the Reference Signal Receiving Power (RSRP), the Reference Signal Receiving Quality (RSRQ), and the Signal-to-Noise Ratio (SNR/SINR) may be measured by the user equipment for more than once and the measurement result is reported to the network equipment for more than once until the power adjustment of the downlink signals is completed by the network equipment. Preferably, when the user equipment is configured, by the network equipment, to perform beam correspondence based on the Channel-State Information Reference Signal (CSI-RS), the user equipment may measure and report the Synchronization Signal and PBCH block (SSB) for more than once until the power adjustment of the Synchronization Signal and PBCH block (SSB) is completed by the network equipment. Preferably, it is beneficial to improve the accuracy of measurement that the network equipment configures the user equipment to measure the network layer.

Alternatively, the resource for performing uplink transmitting beam sweeping may comprise an uplink Sounding Reference Signal (SRS) resource.

Alternatively, the performing uplink transmitting beam sweeping may comprise: sweeping the uplink transmitting beam by encoding the uplink Sounding Reference Signal (SRS) into different uplink transmitting beams.

Alternatively, the communication method may further comprise: transmitting an uplink signal with the first uplink transmitting beam determined according to the measurement result for the downlink signals, when an indication of not enabling the uplink transmitting beam sweeping sent by the network equipment is received.

Alternatively, the measurement result of the uplink transmitting beam sweeping fed back by the network equipment may comprise an uplink sounding reference signal resource indication (SRI). Wherein the determining the second uplink transmitting beam according to the measurement result of the uplink transmitting beam sweeping may comprise: determining the uplink transmitting beam corresponding to the best uplink sounding reference signal indicated by the uplink sounding reference signal resource indication as the second uplink transmitting beam of the user equipment.

According to an exemplary embodiment of the present disclosure, there is provided a communication method performed by a network equipment, comprising: receiving indication information for beam correspondence sent by a user equipment; determining whether to enable uplink transmitting beam sweeping of the user equipment according to the received indication information for beam correspondence, and sending an indication of whether to enable uplink transmitting beam sweeping of the user equipment to the user equipment; allocating an uplink sounding reference signal resource to the user equipment according to the received indication information for beam correspondence, when it is determined to enable uplink transmitting beam sweeping of the user equipment; measuring the beams swept by the user equipment in the uplink transmitting beam sweeping, and feeding back the measurement result of the uplink transmitting beam sweeping to the user equipment, to control the user equipment to determine an uplink transmitting beam for transmitting an uplink signal.

Alternatively, the communication method may further comprise adjusting powers of the downlink signals. After the indication information for beam correspondence is received by the network equipment, the indication information for beam correspondence is compared with a preset threshold condition. If the preset threshold condition is not satisfied, the network equipment adjusts the powers of the downlink signals until indication information for beam correspondence which satisfies the preset threshold condition is received by the network equipment. Preferably, after the measurement result for the Reference Signal Receiving Power (RSRP), the Reference Signal Receiving Quality (RSRQ), and the Signal-to-Noise Ratio (SNR/SINR) of the downlink signals reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the preset threshold condition is not satisfied, the network equipment adjusts the powers of the downlink signals until a measurement result which satisfies the preset threshold condition is received by the network equipment.

Alternatively, the adjusting the powers of the downlink signals may comprise performing power adjustment on one or more of a plurality of types of the downlink signals. Preferably, when the Channel-State Information Reference Signal (CSI-RS) is configured by the network equipment as the reference signal for beam correspondence, the network equipment adjusts the power of the Synchronization Signal and PBCH block (SSB) to the lowest level. After the measurement result for the Reference Signal Receiving Power (RSRP), the Reference Signal Receiving Quality (RSRQ), and the Signal-to-Noise Ratio (SNR/SINR) of the Synchronization Signal and PBCH block (SSB) reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the preset threshold condition is not satisfied, the network equipment reduces the powers of the downlink signals until a measurement result which satisfies the preset threshold condition is received by the network equipment.

Alternatively, the adjusting the powers of the downlink signals may comprise adjusting the powers of the downlink signals with different Angles of Arrival (AoAs). When the AoAs of the downlink signals change with respect to the user equipment, the powers of the downlink signals may be adjusted, so that the powers of the downlink signals are dynamically adjusted when the AoAs of the downlink signals change.

Alternatively, the communication method may further comprise: allocating the number of beams required for the uplink transmitting beam sweeping according to the received indication information for beam correspondence, when it is determined to enable the uplink transmitting beam sweeping of the user equipment.

Alternatively, the allocating an uplink sounding reference signal resource to the user equipment according to the received indication information for beam correspondence may comprise: allocating the uplink sounding reference signal resource according to the number of beams required for uplink transmitting beam sweeping.

Alternatively, the determining whether to enable uplink transmitting beam sweeping of the user equipment according to the received indication information for beam correspondence may comprise: determining whether to enable uplink transmitting beam sweeping of the user equipment according to the received indication information for beam correspondence and preset information for beam management.

Alternatively, the preset information for beam management may comprise at least a beam correspondence capability of the user equipment and/or an uplink transmitting beam management capability of the user equipment.

According to an exemplary embodiment of the present disclosure, there is provided a user equipment. The user equipment comprises: a signal measuring unit, configured to measure downlink signals; a first determining unit, configured to determine a downlink receiving beam and a first uplink transmitting beam according to a measurement result for the downlink signals; a information generating and sending unit, configured to generate indication information for beam correspondence according to the measurement result for the downlink signals and/or preset user equipment information, and to send, to a network equipment, the generated indication information for beam correspondence with the determined first uplink transmitting beam; a uplink sweeping unit, configured to perform uplink transmitting beam sweeping according to the resource for performing uplink transmitting beam sweeping allocated by the network equipment, when an indication to enable uplink transmitting beam sweeping of the user equipment sent by the network equipment is received; a second determining unit, configured to receive, with the determined downlink receiving beam, the measurement result of the uplink transmitting beam sweeping fed back by the network equipment, and to determine a second uplink transmitting beam according to the measurement result of the uplink transmitting beam sweeping; and a first transmitting unit, configured to transmit an uplink signal with the determined second uplink transmitting beam.

Alternatively, the measured downlink signals may comprise at least one of a Synchronization Signal and PBCH block and a Channel-State Information Reference Signal, and the measurement result for the downlink signals may comprise at least one of RSRP, RSRQ and SNR/SINR of the downlink signals. The measurement result for the downlink signals may be a measurement result for a physical layer or a network layer. Wherein, the information generating and sending unit may be configured to generate indication information for beam correspondence according to the RSRP and/or the RSRQ and/or the SNR/SINR in a current measurement result.

Alternatively, the first determining unit may be configured to select a beam with the highest RSRP measurement value of the downlink signals as the downlink receiving beam; and to determine a beam corresponding to the downlink receiving beam by the beam correspondence as the first uplink transmitting beam.

Alternatively, the user equipment information may comprise at least one of a current receiving beam index, a current transmitting beam index, other auxiliary information of a current receiving/transmitting beam, and antenna array information of the user equipment.

Alternatively, the information generating and sending unit may be configured to generate indication information for beam correspondence according to the current transmitting beam index and a mapping table, wherein the mapping table comprises a mapping relationship between transmitting beam indexes and beam correspondence tolerances.

Alternatively, the user equipment may further comprise a mapping table generating unit configured to generate the mapping table by a calibration test.

Alternatively, the mapping table generating unit may be configured to measure the power of the second transmitting beam and the power of the first transmitting beam separately, to calculate the difference between the power of the second transmitting beam and the power of the first transmitting beam as a beam correspondence tolerance, and to record the first transmitting beam index as the transmitting beam index, for each space test point of the user equipment; to perform the same calibration test by traversing through all the space test points to obtain a beam correspondence tolerance of each transmitting beam index, and to generate the mapping table according to the beam correspondence tolerance of each transmitting beam index.

Alternatively, the information generating and sending unit may further be configured to use a maximum value of the beam correspondence tolerance as the beam correspondence tolerance of the transmitting beam index, when the same transmitting beam index is mapped to multiple beam correspondence tolerances.

Alternatively, the indication information for beam correspondence may comprise at least one of one or more binary indication information indicating true or false, one or more decibel data information representing gain, one or more quantity information representing the number of sweeping beams, and one or more data representing the measurement result for the Reference Signal Receiving Power (RSRP), the Reference Signal Receiving Quality (RSRQ), and the Signal-to-Noise Ratio (SNR/SINR) of the downlink signals.

Alternatively, the indication information for beam correspondence may be transmitted to the network equipment by a signaling in which the user equipment reports the measurement result for the Reference Signal Receiving Power (RSRP), the Reference Signal Receiving Quality (RSRQ), and the Signal-to-Noise Ratio (SNR/SINR) of the downlink signals.

Alternatively, the indication information for beam correspondence may be used as a basis for the network equipment to adjust the powers of the downlink signals, and is transmitted to the network equipment for more than once until the power adjustment of the downlink signals is completed by the network equipment. Preferably, the Reference Signal Receiving Power (RSRP), the Reference Signal Receiving Quality (RSRQ), and the Signal-to-Noise Ratio (SNR/SINR) may be measured by the user equipment for more than once and the measurement result is reported to the network equipment for more than once until the power adjustment of the downlink signals is completed by the network equipment. Preferably, when the user equipment is configured, by the network equipment, to perform beam correspondence based on the Channel-State Information Reference Signal (CSI-RS), the user equipment may measure and report the Synchronization Signal and PBCH block (SSB) for more than once until the power adjustment of the Synchronization Signal and PBCH block (SSB) is completed by the network equipment. Preferably, it is beneficial to improve the accuracy of measurement that the network equipment configures the user equipment to measure the network layer.

Alternatively, the resource for performing uplink transmitting beam sweeping may comprise an uplink sounding reference signal resource.

Alternatively, the uplink sweeping unit may be configured to sweep the uplink transmitting beam by encoding the uplink sounding reference signal into different uplink transmitting beams.

Alternatively, the user equipment may further comprise a first transmitting unit, configured to transmit an uplink signal with the first uplink transmitting beam determined according to the measurement result for the downlink signals, when an indication of not enabling the uplink transmitting beam sweeping sent by the network equipment is received.

Alternatively, the measurement result of the uplink transmitting beam sweeping fed back by the network equipment may comprise an uplink sounding reference signal resource indication (SRI). Wherein, the second determining unit may be configured to determine the uplink transmitting beam corresponding to the best uplink sounding reference signal indicated by the uplink sounding reference signal resource indication as the second uplink transmitting beam of the user equipment.

According to an exemplary embodiment of the present disclosure, there is provided a network equipment. The network equipment comprises: a information receiving unit, configured to receive indication information for beam correspondence sent by a user equipment; a determined result sending unit, configured to determine whether to enable uplink transmitting beam sweeping of the user equipment according to the received indication information for beam correspondence, and to send an indication of whether to enable uplink transmitting beam sweeping of the user equipment to the user equipment; a resource allocating unit, configured to allocate an uplink sounding reference signal resource to the user equipment according to the received indication information for beam correspondence, when it is determined to enable uplink transmitting beam sweeping of the user equipment; and a measuring and result feedback unit, configured to measure the beams swept by the user equipment in the uplink transmitting beam sweeping, and feeding back the measurement result of the uplink transmitting beam sweeping to the user equipment, to control the user equipment to determine an uplink transmitting beam for transmitting an uplink signal.

Alternatively, the communication equipment may further comprise a power adjusting unit configured to adjust powers of the downlink signals. After the indication information for beam correspondence is received by the network equipment, the indication information for beam correspondence is compared with a preset threshold condition. If the preset threshold condition is not satisfied, the network equipment adjusts the powers of the downlink signals by the power adjusting unit until indication information for beam correspondence which satisfies the preset threshold condition is received by the network equipment. Preferably, after the measurement result for the Reference Signal Receiving Power (RSRP), the Reference Signal Receiving Quality (RSRQ), and the Signal-to-Noise Ratio (SNR/SINR) of the downlink signals reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the preset threshold condition is not satisfied, the network equipment adjusts the powers of the downlink signals by the power adjusting unit until a measurement result which satisfies the preset threshold condition is received by the network equipment.

Alternatively, the power adjusting unit may be configured to perform power adjustment on one or more of a plurality of types of the downlink signals. Preferably, when the Channel-State Information Reference Signal (CSI-RS) is configured by the network equipment as the reference signal for beam correspondence, the network equipment adjusts the power of the Synchronization Signal and PBCH block (SSB) to the lowest level by the power adjusting unit. After the measurement result for the Reference Signal Receiving Power (RSRP), the Reference Signal Receiving Quality (RSRQ), and the Signal-to-Noise Ratio (SNR/SINR) of the Synchronization Signal and PBCH block (SSB) reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the preset threshold condition is not satisfied, the network equipment reduces the powers of the downlink signals by the power adjusting unit until a measurement result which satisfies the preset threshold condition is received by the network equipment.

Alternatively, the power adjusting unit may be further configured to adjust the powers of the downlink signals with different Angles of Arrival (AoAs). When the AoAs of the downlink signals change with respect to the user equipment, the powers of the downlink signals may be adjusted by the power adjusting unit, so that the powers of the downlink signals are dynamically adjusted when the AoAs of the downlink signals change.

Alternatively, the network equipment may further comprise a number of beams allocating unit, configured to allocate the number of beams required for the uplink transmitting beam sweeping according to the received indication information for beam correspondence, when it is determined to enable the uplink transmitting beam sweeping of the user equipment.

Alternatively, the resource allocating unit may be configured to allocate the uplink sounding reference signal resource according to the number of beams required for uplink transmitting beam sweeping.

Alternatively, the determined result sending unit may be configured to determine whether to enable uplink transmitting beam sweeping of the user equipment according to the received indication information for beam correspondence and preset information for beam management.

Alternatively, the preset information for beam management may comprise at least a beam correspondence capability of the user equipment and/or an uplink transmitting beam management capability of the user equipment.

According to an exemplary embodiment of the present disclosure, a computer readable storage medium stored with a computer program, when the computer program is executed by a processor, the communication method according to the present disclosure is implemented.

According to an exemplary embodiment of the present disclosure, there is provided a communication equipment, comprising a processor, a receiver, for adjusting the direction of a downlink receiving beam, sweeping and tracking the downlink receiving beam, receiving a downlink radio frequency signal, converting the downlink radio frequency signal to a baseband signal, and transmitting the baseband signal to the processor; a transmitter, for adjusting the direction of the uplink transmitting beam, sweeping and tracking the uplink transmitting beam, converting the baseband signal transmitted by the processor into a radio frequency signal and transmitting the radio frequency signal through the uplink transmitting beam; and a memory stored with a computer program, wherein when the computer program is executed by a processor, the communication method according to the present disclosure is implemented.

The communication method, and the user equipment and the network equipment performing the communication method according to the exemplary embodiments of the present disclosure, by adding indication information for beam correspondence at the user equipment side, it contributes to the network equipment to decide whether to enable the uplink transmitting beam sweeping of the user equipment, thereby saving the overhead of network resources and the power consumption of the user equipment as much as possible; at the same time, by including the required information of the number of uplink transmitted beams in the beam correspondence indication information, it contributes to configure the number of sweeping beams adaptively, and improve the efficiency of the beam correspondence of the system. In addition, the user equipment can use the measurement result for the downlink signals and combine the user equipment information to generate indication information for beam correspondence, thereby providing more effective information to the network equipment, so the network equipment can make a more reasonable decision whether to enable the uplink beam sweeping of the user equipment; when the uplink beam sweeping needs to be enabled, the network equipment may adaptively allocate the number of beams for uplink sweeping according to the indication information provided by the user equipment. In addition, the user equipment can use multiple methods to generate effective indication information for network equipment to make decisions, which saves system resources, improves the effect of beam correspondence, enables the user equipment to perform adaptive uplink beam sweeping, and effectively guarantees a balance between the performance and the power consumption of the user equipment.

Additional aspects and/or advantages of the present general inventive concept will be set forth in part in the description which follows, still a portion will be apparent from the description or may be learned by the implementation of the general concept of the present disclosure.

### MODE FOR THE INVENTION

Reference will now be made in detail to exemplary embodiments of the present disclosure, and examples of the embodiments are illustrated in the accompanying drawings, wherein same reference numerals refer to same parts throughout. The embodiments will be illustrated below, by referring to the accompanying drawings, so as to explain the present disclosure.

One of the main features of the fifth generation mobile communication system (5G) is a use of a new radio interface (NR). Flexible beam control is one of the important features of the new radio interface technology, especially in 5G millimeter wave communication systems. Therefore, good beam management is especially important for system performance. From a perspective of communication system link, the beam management includes uplink transmitting beam management and downlink beam management; from a perspective of equipment itself, the beam management includes receiving beam management and transmitting beam management. In general, beam management is implemented through beam sweeping and system measurement; on the other hand, beam management can also be implemented in part by beam correspondence. According to the antenna reciprocity between uplink and downlink wireless channels, the directions of the uplink beam and the downlink beam of a wireless communication link are the same, and the directions of the receiving beam and the transmitting beam of an equipment are the same, and this feature is called beam correspondence.

For a user equipment (UE), after determining a receiving beam through downlink receiving beam sweeping and measurement, the direction of the receiving beam can be directly used as the direction of the UE's uplink transmitting beam according to the beam correspondence, or only a few uplink transmitting beam sweeping are performed based on the downlink receiving beam sweeping and measurement results to determine the uplink transmitting beam, thereby omitting or reducing the processes of sweeping and measurement for the uplink transmitting beam, thus achieving the effects of saving power for the user equipment and saving resource overhead for a network equipment. In view of significant improvement in user experience and system performance brought by the user equipment supporting the beam correspondence function, beam correspondence has been defined as a function that must be supported by smartphone-like millimeter wave user equipment in the standardization of 5G. The current standard is divided into two categories according to the difference of the user equipment's capability to support beam correspondence. One type is that a user equipment is able to directly determine the direction of the uplink transmitting beam completely based on the direction of the downlink receiving beam without uplink transmitting beam sweeping, and thus it can meet a peak transmitting power radio frequency requirement and a spherical coverage radio frequency requirement, and the beam correspondence capability flag bit of this type of user equipment is marked as 1. The other type is that a user equipment determines the direction of the uplink transmitting beam based on both of the downlink beam sweeping and measurement results thereof and further incorporating a certain uplink transmitting beam sweeping, and meet the peak transmitting power radio frequency requirement and the spherical coverage radio frequency requirement. This other type of user equipment further need to meet a beam correspondence tolerance radio frequency requirement, that is, the spherical coverage performance difference corresponding to whether to incorporate the uplink transmitting beam sweeping or not is within a few decibels. The beam correspondence capability flag bit of this type of equipment is marked as 0. A beam correspondence capability flag bit being 0 does not mean that the beam correspondence capability is not available. The beam correspondence capability of the user equipment is transferred to the network equipment through a radio interface signaling.

According to the current technology, for a user equipment with a beam correspondence capability of 1, the benefit of enabling the uplink transmitting beam sweeping is unknown. For a user equipment with a beam correspondence capability of 0, the average benefit within the range of spherical coverage of enabling the uplink transmitting beam sweeping is within beam correspondence tolerance. In particular, the beam correspondence needs to meet certain side conditions such as Signal-to-Noise Ratio. When the network signal's status does not meet the side conditions of the beam correspondence, reduction of a link gain of the user equipment due to a degradation of the beam correspondence capability cannot be known by the network equipment. It can be seen that the decision basis for the network equipment to decide whether to enable the uplink transmitting beam sweeping of the user equipment is very limited, and the benefit information of the link gain caused by enabling the uplink transmitting beam sweeping of the user equipment is also insufficient. This will increase the uncertainty of system performance.

According to the current technology, after the network equipment enables the uplink transmitting beam sweeping of the user equipment, the number of beams in uplink sweeping used by the user equipment for beam correspondence is fixed to eight. Under different network signal conditions, under different user equipment antenna designs, or under different beam widths and beam distributions, the fixed number of beams in uplink sweeping may be redundant or inadequate, resulting in waste of system resources or insufficient performance.

According to the current technology, even for a user equipment with a beam correspondence capability of 0, the expected benefit of enabling its uplink transmitting beam sweeping is the average within the spherical coverage, and from the perspective of the actual use of the user equipment, the user equipment's incoming signal direction is from a specific angle of arrival (AoA). Depending on the angle of arrival, the beam correspondence performance of the user equipment is different, whether it is a user equipment with a beam correspondence capability of 1 or a user equipment with a beam correspondence capability of 0, there are angles of arrival with a very high ratio, which have good beam correspondence capability and small beam correspondence tolerance. Enabling the uplink transmitting beam sweeping at these angles of arrival will cause unnecessary waste of system resources.

Therefore, there are still many deficiencies in current beam management and beam correspondence technology, and new technologies are needed to improve the efficiency and performance of beam management and beam correspondence.

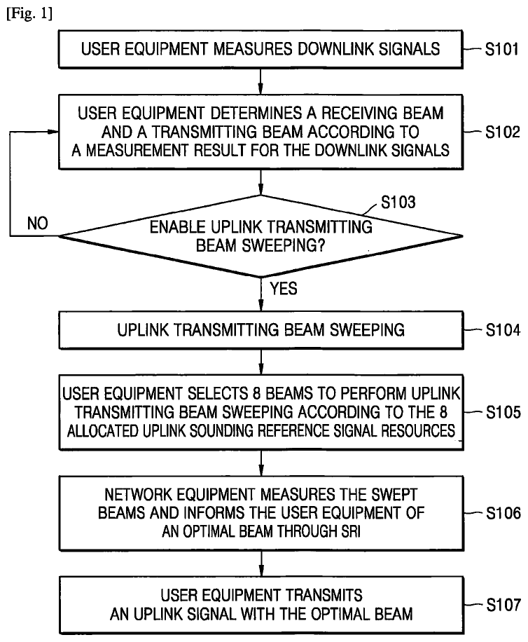

FIG. 1 illustrates a schematic flowchart of a method for implementing beam management and beam correspondence in the prior art.

Referring to FIG. 1, in step S101, a user equipment measures downlink signals. In step S102, the user equipment determines a receiving beam and a transmitting beam according to the measurement result for the downlink signals. The user equipment completes the beam correspondence process only by measuring the downlink signals without enabling the uplink transmitting beam sweeping. In step S103, a network equipment determines whether to enable uplink transmitting beam sweeping of the user equipment according to the measurement result for the downlink signals. In step S104, the network equipment allocates fixed 8 uplink sounding reference signal (SRS) resources. In step S105, the user equipment selects 8 beams to perform uplink transmitting beam sweeping according to the 8 uplink sounding reference signal resources allocated by the network equipment. In step S106, the network equipment measures the swept beams and informs the user equipment of an optimal beam through the uplink Sounding reference signal Resources Indication (SRI). In step S107, after analyzing the SRI, the user equipment transmits an uplink signal with the optimal beam.

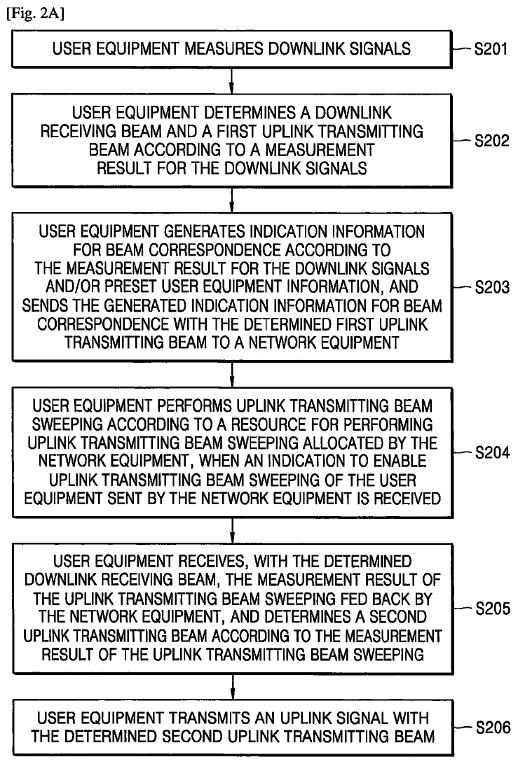

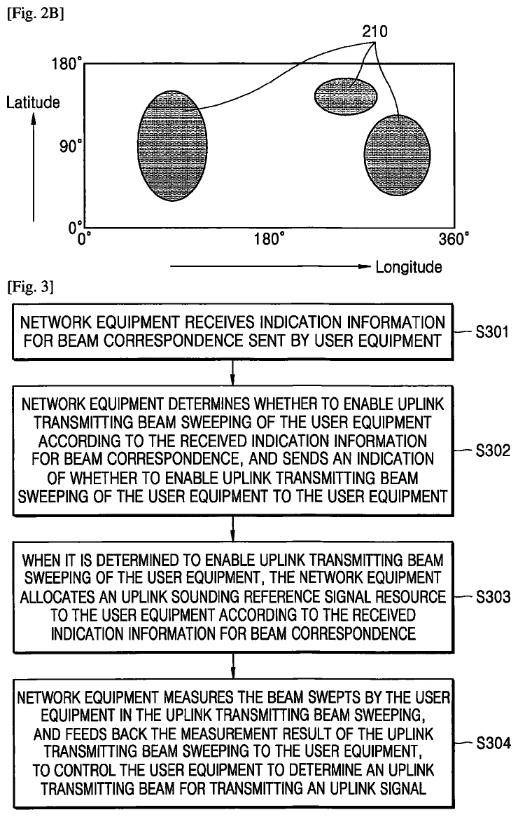

FIG. 2A illustrates a flowchart of a communication method according to one exemplary embodiment of the present disclosure. The technical solution in FIG. 2 is applicable to both a user equipment with a beam correspondence capability of 0 and a user equipment with a beam correspondence capability of 1 which supports uplink transmitting beam management. The user equipment in the embodiments of the present disclosure may include, but is not limited to, such as a mobile-phone, a smart-phone, a notebook computer, a PDA (Personal Digital Assistant), a PAD (Tablet Computer), a desktop computer, a wearable device, a robot, a drone, an IoT terminal and the like devices.

Referring to FIG. 2, in step S201, a user equipment measures downlink signals.

In an exemplary embodiment of the present disclosure, the downlink signals measured by the user equipment may include a Synchronization Signal and PBCH block (SSB), and/or a Channel-State Information Reference Signal (CSI-RS) and the like. When a user equipment measures downlink signals, it may mainly measure one or more of a Reference Signal Receiving Power (RSRP), a Reference Signal Receiving Quality (RSRQ), and a Signal-to-Noise Ratio (SNR/SINR) of the downlink signals, the measurement result for the downlink signals may include the Reference Signal Receiving Power (RSRP), the Reference Signal Receiving Quality (RSRQ) and the Signal-to-Noise Ratio (SNR/SINR) of the downlink signals. In addition, the user equipment may further perform downlink receiving beam sweeping measurements. When the downlink receiving beam sweeping is not needed, it does not hinder the proceeding of step S201. The measurement result for the downlink signals may be either a measurement result for a physical layer (for example, layer 1) or a measurement result for a network layer (for example, layer 3).

In step S202, the user equipment determines a downlink receiving beam and a first uplink transmitting beam according to the measurement result for the downlink signals.

In an exemplary embodiment of the present disclosure, when the user equipment determines the receiving beam and the transmitting beam according to the measurement result for the downlink signals in step S201, a beam with the highest Reference Signal Receiving Power measurement value of the downlink signals may be selected as the receiving beam, and a beam corresponding to the downlink receiving beam by the beam correspondence may be selected as the transmitting beam.

In step S203, the user equipment generates indication information for beam correspondence according to the measurement result for the downlink signals and/or preset user equipment information, and sends the generated indication information for beam correspondence with the first uplink transmitting beam determined in step S201 to a network equipment.

In an exemplary embodiment of the present disclosure, when generating indication information for beam correspondence according to the measurement result for the downlink signals in step S201, the user equipment may generate indication information for beam correspondence according to the Reference Signal Receiving Power (RSRP) and/or the Reference Signal Receiving Quality (RSRQ) and/or the Signal-to-Noise Ratio (SNR/SINR) in a current measurement result. Specifically, when generating the indication information for beam correspondence according to the Signal-to-Noise Ratio in the current measurement result, the user equipment may generate indication information of whether the uplink transmitting beam sweeping is required, decibel data information of link gain improvements due to uplink transmitting beam sweeping, beam quantity information required for uplink transmitting beam sweeping, or may generate a combination of one or more of the above. Herein, the user equipment information may include at least one of a current receiving beam index, a current transmitting beam index, other auxiliary information of a current receiving/transmitting beam, and antenna array information of the user equipment.

In an exemplary embodiment of the present disclosure, when generating indication information for beam correspondence, indication information for beam correspondence may be generated according to the current transmitting beam index and a mapping table. Herein, the mapping table includes a mapping relationship between transmitting beam indexes and beam correspondence tolerances. Specifically, corresponding to different current transmitting beam indexes, the user equipment may generate the indication information of whether the uplink transmitting beam sweeping is required, or the decibel data information of link gain improved due to uplink transmitting beam sweeping, beam quantity information required for uplink transmitting beam sweeping, or may generate a combination of one or more of the above.

In addition, the mapping table may be generated by a calibration test.

In an exemplary embodiment of the present disclosure, when generating the mapping table, for each space test point of the user equipment, the power of the second transmitting beam and the power of the first transmitting beam may be measured separately, the difference between the power of the second transmitting beam and the power of the first transmitting beam may be calculated as a beam correspondence tolerance, and the index of the first transmitting beam may be recorded as the transmitting beam index, and the same calibration test performed by traversing through all the space test points, to obtain a beam correspondence tolerance of each transmitting beam index, and then the mapping table is generated according to the beam correspondence tolerance of each transmitting beam index.

In an exemplary embodiment of the present disclosure, when generating indication information for beam correspondence according to the current transmitting beam index and the mapping table, when the same transmitting beam index is mapped to multiple beam correspondence tolerances, a maximum value of the beam correspondence tolerance is used as the beam correspondence tolerance of the transmitting beam index.

In an exemplary embodiment of the present disclosure, the indication information for beam correspondence comprises at least one of one or more binary indication information indicating true or false, one or more decibel data information representing gain, and one or more quantity information representing the number of sweeping beams, and one or more data representing the measurement result for the Reference Signal Receiving Power (RSRP), the Reference Signal Receiving Quality (RSRQ), and the Signal-to-Noise Ratio (SNR/SINR) and the like of the downlink signals. Herein, the number of beams may be directly expressed by the total number, or the total number of beams may be reflected by the number of beam resource sets and the number of beams included in each beam resource set.

In an exemplary embodiment of the present disclosure, the indication information for beam correspondence may be transmitted to the network equipment by a signaling in which the user equipment reports the measurement result for the Reference Signal Receiving Power (RSRP), the Reference Signal Receiving Quality (RSRQ), and the Signal-to-Noise Ratio (SNR/SINR) and the like of the downlink signals. In an exemplary embodiment of the present disclosure, the indication information for beam correspondence may be used as a basis for the network equipment to adjust the powers of the downlink signals, and is transmitted to the network equipment for more than once until the power adjustment of the downlink signals is completed by the network equipment. Preferably, the Reference Signal Receiving Power (RSRP), the Reference Signal Receiving Quality (RSRQ), and the Signal-to-Noise Ratio (SNR/SINR) may be measured by the user equipment for more than once and the measurement result is reported to the network equipment for more than once until the power adjustment of the downlink signals is completed by the network equipment. Preferably, when the user equipment is configured, by the network equipment, to perform beam correspondence based on the Channel-State Information Reference Signal (CSI-RS), the user equipment may measure and report the Synchronization Signal and PBCH block (SSB) for more than once until the power adjustment of the Synchronization Signal and PBCH block (SSB) is completed by the network equipment. Preferably, it is beneficial to improve the accuracy of measurement that the network equipment configures the user equipment to measure the network layer (for example, layer 3).

Specifically, in step S203, the user equipment may generate the indication information according to the measurement result for the downlink signals in step S201, and may also generate the indication information according to the preset user equipment information (that is, other user equipment information), or generate the indication information according to a combination of the measurement result and other user equipment information; the indication information for beam correspondence generated by the user equipment may be flag bit information of whether an uplink sweeping is required, or may be the decibel number of the expected gain of the uplink sweeping, or may be the number of beams required for uplink sweeping, or may be the measurement result of the user equipment, or some or all of the above-mentioned information. In order to facilitate the understanding of this step, the indication information for beam correspondence is exemplified below.

Combination mode 1: The user equipment generates indication information for beam correspondence according to the Signal-to-Noise Ratio in the measurement result for the downlink signals in step S201. Herein, the generated indication information for beam correspondence includes the decibel number of the expected gain of the uplink sweeping.

In combination mode 1, the decibel number of the expected gain of the uplink sweeping may be indicated according to the difference between the Signal-to-Noise Ratio in the current measurement result and the Signal-to-Noise Ratio in the beam correspondence side condition, as shown in Table 1. The decibel number of the expected gain of the uplink sweeping may also be indicated according to the absolute value of the Signal-to-Noise Ratio in the current measurement result, as shown in Table 2. The numbers in the tables are for illustrative purposes only and may be adjusted flexibly during actual implementation.

TABLE 1

| Difference between current SNR | Expected gain of the uplink |
|---|---|
| and side condition SNR (dB) | sweeping (dB) |
| [symbol] 0 | a |
| −1 | b |
| −2 | c |
| −3 | d |
| . . . | . . . |

TABLE 2

| | Expected gain of the uplink |
|---|---|
| Current SNR (dB) | sweeping (dB) |
| [symbol] 30 | e |
| 10~30 | f |
| 0~10 | g |
| −3~0 | h |
| . . . | . . . |

Combination mode 2: The user equipment generates indication information for beam correspondence according to the Signal-to-Noise Ratio in the measurement result for the downlink signals in step S201. Herein, the generated indication information for beam correspondence includes the beam index required for the uplink sweeping.

In combination mode 2, similar to combination mode 1, the number of beams required for the uplink sweeping may be indicated according to the Signal-to-Noise Ratio in the current measurement result. When the current Signal-to-Noise Ratio is in a different value range, it may indicate the number of beams required for different uplink sweeping. Generally, the lower the Signal-to-Noise Ratio, the greater the indicated number of beams required for the uplink sweeping.

Combination mode 3: The user equipment generates indication information for beam correspondence according to the current transmitting beam index and its auxiliary information. Herein, the generated indication information for beam correspondence includes flag bit information of whether uplink sweeping is required and the decibel number of the expected gain of the uplink sweeping.

In combination mode 3, the user equipment uses the current transmitting beam index to generate indication information for beam correspondence. When the current transmitting beam index is known, a calibration test method of beam correspondence tolerance may be used to obtain the mapping relationship between the transmitting beam and the gain of the uplink transmitting beam sweeping. When the current beam index is known, the expected gain of the uplink sweeping corresponding to the transmitting beam may be obtained through the mapping. As shown in FIG. 2B, the three-dimensional spherical test result of the beam correspondence tolerance is developed into a plane according to the angle between an abscissa and an ordinate. A gray area 210 represents spatial azimuth angles of the beam correspondence tolerance greater than or equal to X decibels, and the other white areas 220 represent spatial azimuth angles of the beam correspondence tolerance less than X decibels. For each test point in the gray areas 210, during the test, the transmitting beam indexes used when the uplink transmitting beam sweeping is not enabled is recorded, and the expected gain of the uplink transmitting beam sweeping is marked as X decibels (or one value greater than X decibels); for other transmitting beam indexes in the gray areas 210 that are not used during the test for all test points, the expected gain of the uplink transmitting beam sweeping is marked as 0 dB (or a value between 0 and X). For the user equipment that has performed the above-mentioned beam correspondence tolerance calibration test and mapped the transmitting beam with the expected gain information of the uplink sweeping, the transmitting beam index may be used to generate the flag information of whether the uplink sweeping is required and the decibel number of the expected gain of the uplink sweeping.

Similarly, the calibration test results of the beam correspondence tolerance may be distinguished at finer intervals. For example, the beam correspondence tolerance is less than the azimuth angle of X decibels, the beam correspondence tolerance is between the azimuth angle of X˜Y decibels, and the beam correspondence tolerance is between the azimuth of Y˜Z decibels, . . . , so that the decibels of the expected gain of the finer uplink sweeping may be indicated according to the transmitting beam index, as shown in Table 3.

TABLE 3

| | Expected gain of the uplink |
|---|---|
| Beam correspondence tolerance | sweeping for the corresponding |
| (dB) | beam (dB) |
| 0~X | 0 |
| X~Y | X |
| Y~Z | Y |
| . . . | . . . |

If there is more than one expected gain of the uplink sweeping corresponding to one beam, the largest one is selected as the expected gain of the uplink sweeping corresponding to this one beam. Preferably, a calibration test of a corresponding beam correspondence tolerance may be performed for different states of the user equipment (for example, a sensor state, a holding state, etc.), and use the same calibration results as the calibration test status when generating the beam correspondence indication.

Combination mode 4: The user equipment generates indication information for beam correspondence according to the antenna array information of the user equipment. Herein, the generated indication information for beam correspondence includes the number of beams required for uplink sweeping.

In combination mode 4, the user equipment may generate the number of beams required for uplink sweeping according to the number of antenna elements of its own antenna array. Generally, the larger the number of antenna elements of each antenna array and the narrower the sweeping beams, the larger the number of beams required for uplink sweeping.

The combination modes given above are only limited examples of implementing step S203 in the embodiment of the present application. The specific implementation is not limited to these combinations, and in actual implementation, multiple combinations of combinations and/or multiple weighted combinations may be performed.

In step S204, when an indication to enable uplink transmitting beam sweeping of the user equipment sent by the network equipment is received, the user equipment performs uplink transmitting beam sweeping according to a resource for performing uplink transmitting beam sweeping allocated by the network equipment.

In an exemplary embodiment of the present disclosure, the resource for performing uplink transmitting beam sweeping includes an uplink sounding reference signal resource. In this way, when performing uplink transmitting beam sweeping, the uplink transmitting beam sweeping may be performed by encoding the uplink sounding reference signal into different uplink transmitting beams. The resources for performing the uplink transmitting beam sweeping allocated by the network equipment may be, for example, N uplink sounding reference signal resources that are adaptively allocated, thereby avoiding the defect that only a fixed number of beams for uplink sweeping are allocated in the prior art.

In addition, when an indication of disable of the uplink transmitting beam sweeping determined by the network equipment according to the indication information for beam correspondence is received, the user equipment may transmit an uplink signal with the first uplink transmitting beam determined according to the measurement result for the downlink signals.

In step S205, the user equipment receives, with the downlink receiving beam determined in step S202, the measurement result of the uplink transmitting beam sweeping fed back by the network equipment, and determines a second uplink transmitting beam according to the measurement result of the uplink transmitting beam sweeping.

In an exemplary embodiment of the present disclosure, after performing uplink transmitting beam sweeping in step S204, the network equipment performs uplink transmitting beam sweeping to perform measurement and feeds back the measurement result to the user equipment. The measurement result of the uplink transmitting beam sweeping fed back by the network equipment may include an indication of the uplink sounding reference signal resource. In this way, when the second uplink transmitting beam is determined according to the measurement result of the uplink transmitting beam sweeping, the uplink transmitting beam corresponding to the best uplink sounding reference signal indicated by the indication of the uplink sounding reference signal resource may be determined as the second uplink transmitting of the user equipment beam.

In step S206, the user equipment transmits an uplink signal with the determined second uplink transmitting beam.

FIG. 3 illustrates a flowchart of a communication method according to another exemplary embodiment of the present disclosure. The communication method in FIG. 3 is applicable to a network equipment. The network equipment in the embodiments of the present disclosure may include, but are not limited to, such as a base station, repeaters, an integrated access and backhaul device, a hotspot, an ad hoc network node, and a test equipment configured with system simulation functions.

Referring to FIG. 3, in step S301, a network equipment receives indication information for beam correspondence sent by a user equipment.

In an exemplary embodiment of the present disclosure, after the indication information for beam correspondence is received in step S301, the network equipment may adjust the powers of the downlink signals according to the received indication information for beam correspondence. The indication information for beam correspondence may include the measurement result for the downlink signals. In one example, when the Channel-State Information Reference Signal (CSI-RS) is configured by the network equipment as the reference signal for beam correspondence, the network equipment adjusts the power of the Synchronization Signal and PBCH block (SSB) to the lowest level. After the measurement result for the Reference Signal Receiving Power (RSRP), the Reference Signal Receiving Quality (RSRQ), and the Signal-to-Noise Ratio (SNR/SINR) of the Synchronization Signal and PBCH block (SSB) reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the threshold condition is not satisfied, the network equipment reduces the powers of the downlink signals until a measurement result which satisfies the preset threshold condition is received by the network equipment. If it is assumed that the threshold conditions for power adjustment of the Synchronization Signal and PBCH block (SSB) by the network equipment is that the Signal-to-Noise Ratio of the Synchronization Signal and PBCH block (SSB) reported by the user equipment is not higher than −3 dB, the power of the downlink signals may be configured for CSI-RS based beam correspondence according to Table 4.

TABLE 4
an example of configuration for CSI-RS based beam correspondence

| | | | | Minimum power of | |
|---|---|---|---|---|---|
| Angle of | NR | Maximum power of SSB | Signal-to-Noise | CSI-RS | Signal-to-Noise |
| Arrival | Frequency | dBm/SCS_{CSI-RS} | dBm/SCS_{CSI-RS} | Ratio of SSB | Ratio of CSI-RS |
| (AoA) | band | SCS_{CSI-RS}—120 kHz | dB | SCS_{CSI-RS}—120 kHz | dB |
| All AoAs | n257 | For each AoA, | ≤−3 | −96.4 | ≥6 |
| | n258 | the initial SSB power is | | −96.4 | |
| | n260 | set to be consistent with | | −92.1 | |
| | | the CSI-RS power, and | | −96.4 | |
| | | then is reduced until the | | | |
| | | SSB signal-to-noise ratio | | | |
| | n261 | reported by the user | | | |
| | | equipment is not higher | | | |
| | | than −3 dB | | | |

In an exemplary embodiment of the present disclosure, in adjusting the powers of the downlink signals, power adjustment may be performed just on one or more of a plurality of types of the downlink signals. Preferably, when the Channel-State Information Reference Signal (CSI-RS) is configured by the network equipment as the reference signal for beam correspondence, the network equipment adjusts the power of the Synchronization Signal and PBCH block (SSB) to the lowest level. After the measurement result for the Reference Signal Receiving Power (RSRP), the Reference Signal Receiving Quality (RSRQ), and the Signal-to-Noise Ratio (SNR/SINR) of the Synchronization Signal and PBCH block (SSB) reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the threshold condition is not satisfied, the network equipment reduces the powers of the downlink signals until a measurement result which satisfies the preset threshold condition is received by the network equipment.

In an exemplary embodiment of the present disclosure, in adjusting the powers of the downlink signals, the powers of the downlink signals with different Angles of Arrival (AoA) are adjusted. When the AoAs of the downlink signals change with respect to the user equipment, the powers of the downlink signals may be adjusted, so that the powers of the downlink signals are dynamically adjusted when the AoA changes.

In step S302, the network equipment determines whether to enable uplink transmitting beam sweeping of the user equipment according to the received indication information for beam correspondence, and sends an indication of whether to enable uplink transmitting beam sweeping of the user equipment to the user equipment.

In an exemplary embodiment of the present disclosure, the network equipment may incorporate the indication information for beam correspondence received in step S301 to more reasonably decide whether to enable uplink transmitting beam sweeping of the user equipment. For example, if the expected gain of the uplink sweeping included in the instruction information provided in step S301 is 0 or very small, or the number of beams required for the uplink sweeping included in the instruction information is 0, it is not necessary to enable the uplink transmit beam sweeping. If the expected gain of the uplink sweeping included in the instruction information provided in step S301 is high, the network equipment may enable the uplink transmitting beam sweeping of the user equipment by incorporating preset information for beam management (that is, other beam management information). Therefore, when the network equipment determines whether to enable uplink transmit beam sweeping of the user equipment according to the received indication information for beam correspondence, the network equipment may determine whether to enable uplink transmit beam sweeping of the user equipment according to the received indication information for beam correspondence and preset information for beam management.

In an exemplary embodiment of the present disclosure, the preset information for beam management includes at least a beam correspondence capability of the user equipment and/or an uplink transmitting beam management capability of the user equipment.

In step S303, when it is determined to enable uplink transmitting beam sweeping of the user equipment, the network equipment allocates an uplink sounding reference signal resource to the user equipment according to the received indication information for beam correspondence.

In an exemplary embodiment of the present disclosure, when it is determined to enable the uplink transmitting beam sweeping of the user equipment, the network equipment allocates the number (for example, N) of beams required for the uplink transmitting beam sweeping according to the received indication information for beam correspondence. In this case, when allocating an uplink sounding reference signal resource to the user equipment according to the received indication information for beam correspondence, the uplink sounding reference signal resource is allocated according to the number of beams required for uplink transmitting beam sweeping. For example, when the number of beams required for uplink transmit beam sweeping is N, N uplink sounding reference signal resources are allocated.

In step S304, the network equipment measures the beams swept by the user equipment in the uplink transmitting beam sweeping, and feeds back the measurement result of the uplink transmitting beam sweeping to the user equipment, to control the user equipment to determine an uplink transmitting beam for transmitting an uplink signal.

In an exemplary embodiment of the present disclosure, after the network equipment feeds back the measurement result of the uplink transmitting beam sweeping to the user equipment, the user equipment may determine a second uplink transmitting beam according to the measurement result of the uplink transmitting beam sweeping, and then transmit an uplink signal with the determined second uplink transmitting beam to perform communication.

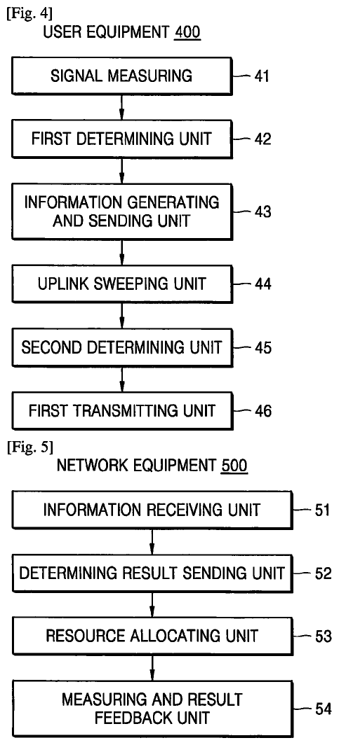

The communication method according to the exemplary embodiments of the present disclosure has been described above with reference to FIG. 2 to FIG. 3. Hereinafter, a user equipment and a network equipment and units thereof according to the exemplary embodiments of the present disclosure will be described with reference to FIG. 4 and FIG. 5.

FIG. 4 illustrates a block diagram of a user equipment according to an exemplary embodiment of the present disclosure.

Referring to FIG. 4, the user equipment 400 includes a signal measuring unit 41, a first determining unit 42, an information generating and sending unit 43, an uplink sweeping unit 44, a second determining unit 45 and a first transmitting unit 46.

The signal measuring unit 41 is configured to measure downlink signals.

In an exemplary embodiment of the present disclosure, the measured downlink signals include at least one of a Synchronization Signal and PBCH block, and a Channel-State Information Reference Signal.

The first determining unit 42 is configured to determine a downlink receiving beam and a first uplink transmitting beam according to the measurement result for the downlink signals.

In an exemplary embodiment of the present disclosure, the measurement result for the downlink signals includes at least one of a Reference Signal Receiving Power (RSRP), a Reference Signal Receiving Quality (RSRQ) and a Signal-to-Noise Ratio (SNR/SINR) of the downlink signals. The measurement result for the downlink signals may be either a measurement result for a physical layer (for example, layer 1) or a measurement result for a network layer (for example, layer 3).

In an exemplary embodiment of the present disclosure, the first determining unit 42 may be configured to generate indication information for beam correspondence according to the Reference Signal Receiving Power and/or the Reference Signal Receiving Quality and/or the Signal-to-Noise Ratio in a current measurement result.

The information generating and sending unit 43 is configured to generate indication information for beam correspondence according to the measurement result for the downlink signals and/or preset user equipment information, and to send, to network equipment, the generated indication information for beam correspondence with the determined first uplink transmitting beam.

In an exemplary embodiment of the present disclosure, the information generating and sending unit 43 may be configured to generate indication information for beam correspondence according to the Reference Signal Receiving Power (RSRP) and/or the Reference Signal Receiving Quality (RSRQ) and/or the Signal-to-Noise Ratio (SNR/SINR) in a current measurement result.

In an exemplary embodiment of the present disclosure, the user equipment information may comprise at least one of a current receiving beam index, a current transmitting beam index, other auxiliary information of a current receiving/transmitting beam, and antenna array information of the user equipment.

In an exemplary embodiment of the present disclosure, the information generating and sending unit 43 may be configured to generate indication information for beam correspondence according to the current transmitting beam index and a mapping table, wherein the mapping table comprises a mapping relationship between transmitting beam indexes and beam correspondence tolerances.

In addition, the user equipment may further include a mapping table generating unit configured to generate the mapping table by a calibration test.

In an exemplary embodiment of the present disclosure, the mapping table generating unit may be configured to measure the power of the second transmitting beam and the power of the first transmitting beam separately, to calculate the difference between the power of the second transmitting beam and the power of the first transmitting beam as a beam correspondence tolerance, and to record the index of the first transmitting beam as the transmitting beam index, for each space test point of the user equipment; to perform the same calibration test by traversing through all the space test points to obtain a beam correspondence tolerance of each transmitting beam index, and to generate the mapping table according to the beam correspondence tolerance of each transmitting beam index.

In an exemplary embodiment of the present disclosure, the information generating and sending unit may further be configured to use a maximum value of the beam correspondence tolerance as the beam correspondence tolerance of the transmitting beam index, when the same transmitting beam index is mapped to multiple beam correspondence tolerances. In an exemplary embodiment of the present disclosure, the indication information for beam correspondence may comprise at least one of one or more binary indication information indicating true or false, one or more decibel data information representing gain, and one or more quantity information representing the number of sweeping beams, and one or more data representing the measurement result for the Reference Signal Receiving Power (RSRP), the Reference Signal Receiving Quality (RSRQ), and the Signal-to-Noise Ratio (SNR/SINR) and the like of the downlink signals.

In an exemplary embodiment of the present disclosure, the indication information for beam correspondence may be transmitted to the network equipment by a signaling in which the user equipment reports the measurement result for the Reference Signal Receiving Power (RSRP), the Reference Signal Receiving Quality (RSRQ), and the Signal-to-Noise Ratio (SNR/SINR) and the like of the downlink signals. In an exemplary embodiment of the present disclosure, the indication information for beam correspondence may be used as a basis for the network equipment to adjust the powers of the downlink signals, and is transmitted to the network equipment for more than once until the power adjustment of the downlink signals is completed by the network equipment. Preferably, the Reference Signal Receiving Power (RSRP), the Reference Signal Receiving Quality (RSRQ), and the Signal-to-Noise Ratio (SNR/SINR) may be measured by the user equipment for more than once and the measurement result is reported to the network equipment for more than once until the power adjustment of the downlink signals is completed by the network equipment. Preferably, when the user equipment is configured, by the network equipment, to perform beam correspondence based on the Channel-State Information Reference Signal (CSI-RS), the user equipment may measure and report the Synchronization Signal and PBCH block (SSB) for more than once until the power adjustment of the Synchronization Signal and PBCH block (SSB) is completed by the network equipment. Preferably, it is beneficial to improve the accuracy of measurement that the network equipment configures the user equipment to measure the network layer (for example, layer 3).

The uplink sweeping unit 44 is configured to perform uplink transmitting beam sweeping according to the resource for performing uplink transmitting beam sweeping allocated by the network equipment, when an indication to enable uplink transmitting beam sweeping of the user equipment sent by the network equipment is received.

In an exemplary embodiment of the present disclosure, the resource for performing uplink transmitting beam sweeping may include an uplink sounding reference signal resource.

In an exemplary embodiment of the present disclosure, the uplink sweeping unit 44 may be configured to sweep the uplink transmitting beam by encoding the uplink sounding reference signal into different uplink transmitting beams.

The second determining unit 45 is configured to receive, with the determined downlink receiving beam, the measurement result of the uplink transmitting beam sweeping fed back by the network equipment, and to determine a second uplink transmitting beam according to the measurement result of the uplink transmitting beam sweeping.

In an exemplary embodiment of the present disclosure, the measurement result of the uplink transmitting beam sweeping fed back by the network equipment may include an uplink sounding reference signal resource indication.

In an exemplary embodiment of the present disclosure, the second determining unit 45 may be configured to determine the uplink transmitting beam corresponding to the best uplink sounding reference signal indicated by the uplink sounding reference signal resource indication as the second uplink transmitting beam of the user equipment.

The first transmitting unit 46 is configured to transmit an uplink signal with the determined second uplink transmitting beam.

In an exemplary embodiment of the present disclosure, the user equipment may further include a first transmitting unit, configured to transmit an uplink signal with the first uplink transmitting beam determined according to the measurement result for the downlink signals, when an indication of not enabling the uplink transmitting beam sweeping sent by the network equipment is received.

FIG. 5 illustrates a block diagram of a network equipment according to an exemplary embodiment of the present disclosure.

Referring to FIG. 5, the network equipment 500 includes an information receiving unit 51, a determined result sending unit 52, a resource allocating unit 53, a measuring and result feedback unit 54.

The information receiving unit 51 is configured to receive indication information for beam correspondence sent by a user equipment.

In an exemplary embodiment of the present disclosure, the network equipment may further comprise a power adjusting unit (not shown) configured to adjust powers of the downlink signals. After the indication information for beam correspondence is received by the network equipment, the indication information for beam correspondence is compared with a preset threshold condition. If the threshold condition is not satisfied, the network equipment adjusts the powers of the downlink signals by the power adjusting unit until indication information for beam correspondence which satisfies the preset threshold condition is received by the network equipment. Preferably, after the measurement result for the Reference Signal Receiving Power (RSRP), the Reference Signal Receiving Quality (RSRQ), and the Signal-to-Noise Ratio (SNR/SINR) of the downlink signals reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the threshold condition is not satisfied, the network equipment adjusts the powers of the downlink signals by the power adjusting unit until a measurement result which satisfies the preset threshold condition is received by the network equipment.

In an exemplary embodiment of the present disclosure, the power adjusting unit may be configured to perform power adjustment on one or more of a plurality of types of the downlink signals. Preferably, when the Channel-State Information Reference Signal (CSI-RS) is configured by the network equipment as the reference signal for beam correspondence, the network equipment adjusts the power of the Synchronization Signal and PBCH block (SSB) to the lowest level by the power adjusting unit. After the measurement result for the Reference Signal Receiving Power (RSRP), the Reference Signal Receiving Quality (RSRQ), and the Signal-to-Noise Ratio (SNR/SINR) of the Synchronization Signal and PBCH block (SSB) reported by the user equipment is received by the network equipment, the network equipment compares the measurement result with a preset threshold condition for the Reference Signal Receiving Power (RSRP), the Reference Signal Receiving Quality (RSRQ) and the Signal-to-Noise Ratio (SNR/SINR). If the threshold condition is not satisfied, the network equipment reduces the powers of the downlink signals by the power adjusting unit until a measurement result which satisfies the preset threshold condition is received by the network equipment.

In an exemplary embodiment of the present disclosure, the power adjusting unit may be further configured to adjust the powers of the downlink signals with different Angles of Arrival (AoA). When the AoAs of the downlink signals change with respect to the user equipment, the powers of the downlink signals may be adjusted by the power adjusting unit, so that the powers of the downlink signals are dynamically adjusted when the AoAs of the downlink signals change.

The determined result sending unit 52 is configured to determine whether to enable uplink transmitting beam sweeping of the user equipment according to the received indication information for beam correspondence, and to send an indication of whether to enable uplink transmitting beam sweeping of the user equipment to the user equipment.

In an exemplary embodiment of the present disclosure, the determined result sending unit 52 may be configured to determine whether to enable uplink transmitting beam sweeping of the user equipment according to the received indication information for beam correspondence and preset information for beam management. Herein, the preset information for beam management may comprise at least a beam correspondence capability of the user equipment and/or an uplink transmitting beam management capability of the user equipment.

The resource allocating unit 53 is configured to allocate an uplink sounding reference signal resource to the user equipment according to the received indication information for beam correspondence, when it is determined to enable uplink transmitting beam sweeping of the user equipment.

In an exemplary embodiment of the present disclosure, the network equipment may further comprise a number of beams allocating unit configured to allocate the number of beams required for the uplink transmitting beam sweeping according to the received indication information for beam correspondence, when it is determined to enable the uplink transmitting beam sweeping of the user equipment. In this case, the resource allocating unit 53 may be configured to allocate the uplink sounding reference signal resource according to the number of beams required for uplink transmitting beam sweeping.

The measuring and result feedback unit 54 is configured to measure the beams swept by the user equipment in the uplink transmitting beam sweeping, and feeding back the measurement result of the uplink transmitting beam sweeping to the user equipment, to control the user equipment to determine an uplink transmitting beam for transmitting an uplink signal.

In addition, according to the exemplary embodiments of the present disclosure, a computer readable storage medium stored with a computer program is provided, when the computer program is executed by a processor, the communication method according to the present disclosure is implemented.

In an exemplary embodiment of the present disclosure, the computer readable storage medium can carry one or more programs that, when executed, the follow steps may be implemented: a user equipment measures downlink signals; the user equipment determines a downlink receiving beam and a first uplink transmitting beam according to a measurement result for the downlink signals; the user equipment generates indication information for beam correspondence according to the measurement result for the downlink signals and/or preset user equipment information, and sends, to a network equipment, the generated indication information for beam correspondence with the determined first uplink transmitting beam; performs uplink transmitting beam sweeping according to a resource for performing uplink transmitting beam sweeping allocated by the network equipment, when an indication to enable uplink transmitting beam sweeping of the user equipment sent by the network equipment is received; receives, with the determined downlink receiving beam, the measurement result of the uplink transmitting beam sweeping fed back by the network equipment, and determines a second uplink transmitting beam according to the measurement result of the uplink transmitting beam sweeping; the user equipment transmits an uplink signal with the determined second uplink transmitting beam.

In an exemplary embodiment of the present disclosure, the computer readable storage medium can carry one or more programs that, when executed, the follow steps may be implemented: receiving indication information for beam correspondence sent by a user equipment; determining whether to enable uplink transmitting beam sweeping of the user equipment according to the received indication information for beam correspondence, and sending an indication of whether to enable uplink transmitting beam sweeping of the user equipment to the user equipment; allocating an uplink sounding reference signal resource to the user equipment according to the received indication information for beam correspondence, when it is determined to enable uplink transmitting beam sweeping of the user equipment; measuring the beams swept by the user equipment in the uplink transmitting beam sweeping, and feeding back the measurement result of the uplink transmitting beam sweeping to the user equipment, to control the user equipment to determine an uplink transmitting beam for transmitting an uplink signal.

The computer readable storage medium may be, for example, but not limited to, an electronic, magnetic, optical, electromagnetic, infrared, or semiconductor system, device, or, equipment or any combination of the above. More specific examples of computer readable storage media may comprise, but not limited to, electrical connections having one or more wires, portable computer disks, hard disks, random access memory (RAM), read only memory (ROM), erasable Programmable read only memory (EPROM or flash memory), optical fiber, portable compact disk read only memory (CD-ROM), optical storage device, magnetic storage device, or any suitable combination of the above mentioned. In the embodiments of the present disclosure, a computer readable storage medium may be any tangible medium that can contain or store a computer program, which can be used by or in connection with an instruction execution system, device, or, equipment. The computer program embodied on the computer readable storage medium can be transmitted by any suitable medium, comprising but not limited to: wire, fiber optic cable, RF (radio frequency), etc., or any suitable combination of the foregoing. The computer readable storage medium can be comprised in any device; it can also be present separately and not incorporated into the device.

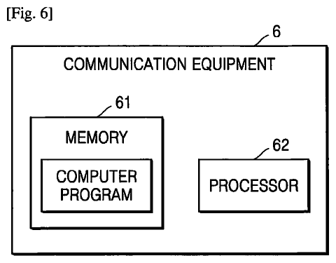

The user equipment and the network equipment performing the communication method according to the exemplary embodiments of the present disclosure have been described above with reference to FIG. 4 and FIG. 5. Hereinafter, a communication equipment according to the exemplary embodiments of the present disclosure will be described with reference to FIG. 6.

FIG. 6 illustrates a schematic diagram of a communication equipment according to an exemplary embodiment of the present disclosure.

Referring to FIG. 6, a communication equipment 6 according to an exemplary embodiment of the present disclosure includes a memory 61, a processor 62, a receiver (not shown), and a transmitter (not shown), a computer program which is stored on the memory 61 and when the computer program is executed by the processor 62, the communication method according to the present disclosure is implemented.

In an exemplary embodiment of the present disclosure, the processor may generate indication information for beam correspondence according to the information transmitted from the receiver, and then send the same to the network equipment through a transmitting module.

In an exemplary embodiment of the present disclosure, when the computer program is executed by the processor 62, the follow steps may be implemented: a user equipment measures downlink signals; the user equipment determines a downlink receiving beam and a first uplink transmitting beam according to a measurement result for the downlink signals; the user equipment generates indication information for beam correspondence according to the measurement result for the downlink signals and/or preset user equipment information, and sends, to a network equipment, the generated indication information for beam correspondence with the determined first uplink transmitting beam; performs uplink transmitting beam sweeping according to a resource for performing uplink transmitting beam sweeping allocated by the network equipment, when an indication to enable uplink transmitting beam sweeping of the user equipment sent by the network equipment is received; receives, with the determined downlink receiving beam, the measurement result of the uplink transmitting beam sweeping fed back by the network equipment, and determines a second uplink transmitting beam according to the measurement result of the uplink transmitting beam sweeping; the user equipment transmits an uplink signal with the determined second uplink transmitting beam.

In an exemplary embodiment of the present disclosure, when the computer program is executed by the processor 62, the follow steps may be implemented: receiving indication information for beam correspondence sent by a user equipment; determining whether to enable uplink transmitting beam sweeping of the user equipment according to the received indication information for beam correspondence, and sending an indication of whether to enable uplink transmitting beam sweeping of the user equipment to the user equipment; allocating an uplink sounding reference signal resource to the user equipment according to the received indication information for beam correspondence, when it is determined to enable uplink transmitting beam sweeping of the user equipment; measuring the beams swept by the user equipment in the uplink transmitting beam sweeping, and feeding back the measurement result of the uplink transmitting beam sweeping to the user equipment, to control the user equipment to determine an uplink transmitting beam for transmitting an uplink signal.

The communication equipment in the embodiments of the present disclosure may include, but are not limited to, such as a mobile-phone, a smart-phone, a notebook computer, a PDA (personal digital assistant), a PAD (tablet), a desktop computer, a wearable device, a robot, a drone, an IoT terminal and the like devices. The communication equipment shown in FIG. 6 is only an example, and should not impose any limitation on the functions and scope of use of the embodiments of the present disclosure.

A communication method, and a user equipment and a network equipment performing the communication method according to an exemplary embodiment of the present disclosure have been described above with reference to FIGS. 1-6. However, it should be understood that the user equipment and the network equipment performing the communication method and units therein shown in FIGS. 4 to 5 may be respectively configured to execute software, hardware, firmware, or any combination of them of a specific function. The communication equipment as shown in FIG. 6 is not limited to including the components shown above, but some components may be added or deleted as needed, and the above components may also be combined.

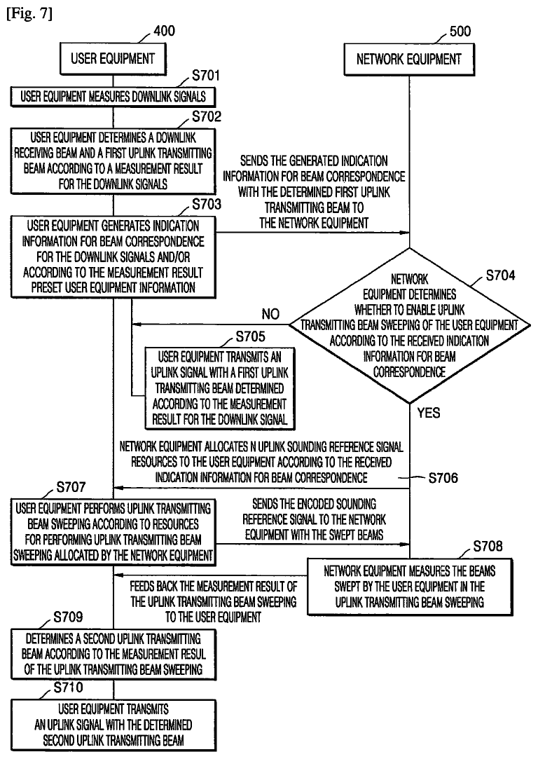

FIG. 7 illustrates a schematic diagram of a communication flow of a communication system 700 including a user equipment 400 and a network equipment 500 according to an exemplary embodiment of the present disclosure.

Referring to FIG. 7, the communication system 700 includes the user equipment 400 and the network equipment 500. The user equipment 400 in the embodiments of the present disclosure may include, but is not limited to, such as a mobile-phone, a smart-phone, a notebook computer, a PDA (Personal Digital Assistant), a PAD (Tablet Computer), a desktop computer, a wearable device, a robot, a drone, an IoT terminal and the like devices. The network equipment 500 in the embodiments of the present disclosure may include, but is not limited to, such as a base station, a repeater, an integrated access and backhaul equipment, a hotspot, an ad hoc network node, and the like.

In step S701, the user equipment measures downlink signals.

In step S702, the user equipment determines a downlink receiving beam and a first uplink transmitting beam according to a measurement result for the downlink signals.

In step S703, the user equipment generates indication information for beam correspondence according to the measurement result for the downlink signals and/or preset user equipment information, and sends the generated indication information for beam correspondence with the determined first uplink transmitting beam to the network equipment.

In step S704, the network equipment receives the indication information for beam correspondence, and determines whether to enable uplink transmitting beam sweeping of the user equipment according to the received indication information for beam correspondence, step S706 is executed if YES, and step S705 is executed if NO.

In step S705, when the network equipment determines not to enable uplink transmitting beam sweeping of the user equipment, the user equipment transmits an uplink signal with a first uplink transmitting beam determined according to the measurement result for the downlink signal.

In step S706, when the network equipment determines to enable uplink transmitting beam sweeping of the user equipment, the network equipment allocates N uplink sounding reference signal resources to the user equipment according to the received indication information for beam correspondence.

In step S707, the user equipment performs uplink transmitting beam sweeping according to resources for performing uplink transmitting beam sweeping allocated by the network equipment, and sends the encoded sounding reference signal to the network equipment with the swept beams.

In step S708, the network equipment measures the beams swept by the user equipment in the uplink transmitting beam sweeping, and feeds back the measurement result of the uplink transmitting beam sweeping to the user equipment.

In step S709, the user equipment receives, with the determined downlink receiving beam, the measurement result of the uplink transmitting beam sweeping fed back by the network equipment, and determines a second uplink transmitting beam according to the measurement result of the uplink transmitting beam sweeping.

In step S710, the user equipment transmits an uplink signal with the determined second uplink transmitting beam.

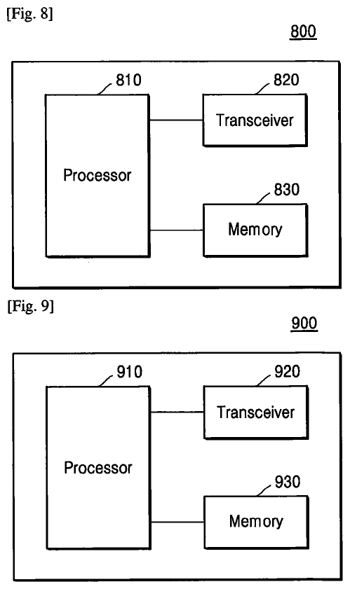

FIG. 8 illustrates a block diagram of a user equipment according to an exemplary embodiment of the present disclosure.

Referring to the FIG. 8, the user equipment 800 may include a processor 810, a transceiver 820 and a memory 830. However, all of the illustrated components are not essential. The user equipment 800 may be implemented by more or less components than those illustrated in FIG. 8. In addition, the processor 810 and the transceiver 820 and the memory 830 may be implemented as a single chip according to another embodiment.

The user equipment 800 may correspond to UE described above. For example, the user equipment 400 may correspond to the UE 400 illustrated in FIG. 4.

The aforementioned components will now be described in detail.

The processor 810 may include one or more processors or other processing devices that control the proposed function, process, and/or method. Operation of the user equipment 800 may be implemented by the processor 810.

The transceiver 820 may include a RF transmitter for up-converting and amplifying a transmitted signal, and a RF receiver for down-converting a frequency of a received signal. However, according to another embodiment, the transceiver 820 may be implemented by more or less components than those illustrated in components.

The transceiver 820 may be connected to the processor 810 and transmit and/or receive a signal. The signal may include control information and data. In addition, the transceiver 820 may receive the signal through a wireless channel and output the signal to the processor 810. The transceiver 820 may transmit a signal output from the processor 810 through the wireless channel.

The memory 830 may store the control information or the data included in a signal obtained by the user equipment 800. The memory 830 may-be connected to the processor 810 and store at least one instruction or a protocol or a parameter for the proposed function, process, and/or method. The memory 830 may include read-only memory (ROM) and/or random access memory (RAM) and/or hard disk and/or CD-ROM and/or DVD and/or other storage devices.

FIG. 9 illustrates a block diagram of a network equipment according to an exemplary embodiment of the present disclosure.

Referring to the FIG. 9, the network equipment 900 may include a processor 910, a transceiver 920 and a memory 930. However, all of the illustrated components are not essential. The network equipment 900 may be implemented by more or less components than those illustrated in FIG. 9. In addition, the processor 910 and the transceiver 920 and the memory 930 may be implemented as a single chip according to another embodiment.

The network equipment 900 may correspond to the network equipment described above. For example, the network equipment 900 may correspond to the network equipment 500 illustrated in FIG. 5.

The aforementioned components will now be described in detail.

The processor 910 may include one or more processors or other processing devices that control the proposed function, process, and/or method. Operation of the network equipment 900 may be implemented by the processor 910.

The transceiver 920 may include a RF transmitter for up-converting and amplifying a transmitted signal, and a RF receiver for down-converting a frequency of a received signal. However, according to another embodiment, the transceiver 920 may be implemented by more or less components than those illustrated in components.

The transceiver 920 may be connected to the processor 910 and transmit and/or receive a signal. The signal may include control information and data. In addition, the transceiver 920 may receive the signal through a wireless channel and output the signal to the processor 910. The transceiver 920 may transmit a signal output from the processor 910 through the wireless channel.

The memory 930 may store the control information or the data included in a signal obtained by the network equipment 900. The memory 930 may be connected to the processor 910 and store at least one instruction or a protocol or a parameter for the proposed function, process, and/or method. The memory 930 may include read-only memory (ROM) and/or random access memory (RAM) and/or hard disk and/or CD-ROM and/or DVD and/or other storage devices.

The communication method, and the user equipment and the network equipment performing the communication method according to the exemplary embodiments of the present disclosure, by adding indication information for beam correspondence at the user equipment side, it contributes to the network equipment to decide whether to enable the uplink transmitting beam sweeping of the user equipment, thereby saving the overhead of network resources and the power consumption of the user equipment as much as possible; at the same time, by including the required information of the number of uplink transmitted beams in the beam correspondence indication information, it contributes to configure the number of sweeping beams adaptively, and improve the efficiency of the beam correspondence of the system. In addition, the user equipment can use the measurement result for the downlink signals and combine the user equipment information to generate indication information for beam correspondence, thereby providing more effective information to the network equipment, so the network equipment can make a more reasonable decision whether to enable the uplink beam sweeping of the user equipment; when the uplink beam sweeping needs to be enabled, the network equipment may adaptively allocate the number of beams for uplink sweeping according to the indication information provided by the user equipment. In addition, the user equipment can use multiple methods to generate effective indication information for network equipment to make decisions, which saves system resources, improves the effect of beam correspondence, enables the user equipment to perform adaptive uplink beam sweeping, and effectively guarantees a balance between the performance and the power consumption of the user equipment.

While the present disclosure has been shown and described with reference to certain exemplary embodiments thereof, it should be understood by those skilled in the art that various changes in form and details may be made therein without departing from the principle and spirit of the present disclosure which are defined by the appended claims.

1. A communication method performed by a user equipment, comprising:
measuring downlink signals;
determining a downlink receiving beam and a first uplink transmitting beam according to a measurement result for the downlink signals;
generating indication information for beam correspondence according to the measurement result for at least one of the downlink signals and preset user equipment information, and sending, to a network equipment, the generated indication information for beam correspondence with the determined first uplink transmitting beam;
performing uplink transmitting beam sweeping according to a resource for performing uplink transmitting beam sweeping allocated by the network equipment, when an indication to enable uplink transmitting beam sweeping of the user equipment sent by the network equipment is received;
receiving, with the determined downlink receiving beam, the measurement result for the uplink transmitting beam sweeping fed back by the network equipment, and determining a second uplink transmitting beam according to the measurement result for the uplink transmitting beam sweeping;
transmitting an uplink signal with the determined second uplink transmitting beam.

2. The communication method according to claim 1,
wherein the measured downlink signals comprise at least one of a Synchronization Signal and PBCH block (SSB) and a Channel-State Information Reference Signal (CSI-RS), and the measurement result for the downlink signals comprises at least one of Reference Signal Receiving Power (RSRP), Reference Signal Receiving Quality (RSRQ) and a Signal-to-Noise Ratio (SNR/SINR) of the downlink signals, the measurement result for the downlink signals is a measurement result for a physical layer or a network layer,
wherein the generating indication information for beam correspondence according to the measurement result for at least one of the downlink signals and the preset user equipment information comprises:
generating indication information for beam correspondence according to at least one of the Reference Signal Receiving Power (RSRP), the Reference Signal Receiving Quality (RSRQ), and the Signal-to-Noise Ratio (SNR/SINR) in a current measurement result.

3. The communication method according to claim 1,
wherein the user equipment information comprises at least one of a current receiving beam index, a current transmitting beam index, other auxiliary information of a current receiving/transmitting beam, and antenna array information of the user equipment,
wherein the generating indication information for beam correspondence comprises:
generating the mapping table which have relationship between transmitting beam indexes and beam correspondence tolerances, by a calibration test; and
generating indication information for beam correspondence according to the current transmitting beam index and the mapping table,
wherein the generating the mapping table comprises:
measuring the power of the second transmitting beam and the power of the first transmitting beam separately, calculating the difference between the power of the second transmitting beam and the power of the first transmitting beam as a beam correspondence tolerance, and
recording the first transmitting beam index as the transmitting beam index, for each space test point of the user equipment,
performing the same calibration test by traversing through all the space test points, and
generating the mapping table according to the beam correspondence tolerance and the transmitting beam index.

4. The communication method according to claim 1,
wherein the indication information for beam correspondence comprises at least one of one or more binary indication information indicating true or false, one or more decibel data information representing gain, one or more quantity information representing the number of sweeping beams, and one or more data representing the measurement result for the Reference Signal Receiving Power (RSRP), the Reference Signal Receiving Quality (RSRQ), and the Signal-to-Noise Ratio (SNR/SINR) of the downlink signals,
wherein the measurement result of the uplink transmitting beam sweeping fed back by the network equipment comprises an uplink sounding reference signal resource indication,
wherein the determining the second uplink transmitting beam according to the measurement result of the uplink transmitting beam sweeping comprises: determining the second uplink transmitting beam of the user equipment, based on the uplink sounding reference signal resource indication.

5. The communication method according to claim 1,
wherein the indication information for beam correspondence may be transmitted to the network equipment by a signaling in which the user equipment reports the measurement result for the Reference Signal Receiving Power, the Reference Signal Receiving Quality, and the Signal-to-Noise Ratio of the downlink signals.

6. The communication method according to claim 5,
wherein the indication information for beam correspondence may be used as a basis for the network equipment to adjust the powers of the downlink signals, and is transmitted to the network equipment for more than once until the power adjustment of the downlink signals is completed by the network equipment,
wherein the measuring the downlink signals comprises measuring the Reference Signal Receiving Power, the Reference Signal Receiving Quality, and the Signal-to-Noise Ratio for more than once, to report the measurement result to the network equipment for more than once.

7. A communication method performed by a network equipment, comprising:
receiving indication information for beam correspondence sent by a user equipment;
determining whether to enable uplink transmitting beam sweeping of the user equipment according to the received indication information for beam correspondence, and sending an indication of whether to enable uplink transmitting beam sweeping of the user equipment to the user equipment;
allocating an uplink sounding reference signal resource to the user equipment according to the received indication information for beam correspondence, when it is determined to enable uplink transmitting beam sweeping of the user equipment;
measuring the beams swept by the user equipment in the uplink transmitting beam sweeping; and
feeding back the measurement result of the uplink transmitting beam sweeping to the user equipment.

8. The communication method according to claim 7,
wherein the determining whether to enable uplink transmitting beam sweeping of the user equipment comprises the determining whether to enable uplink transmitting beam sweeping of the user equipment according to the received indication information for beam correspondence and preset information for beam management,
the method further comprising:
allocating the number of beams required for the uplink transmitting beam sweeping according to the received indication information for beam correspondence, when it is determined to enable the uplink transmitting beam sweeping of the user equipment.

9. The communication method according to claim 8, further comprising:
adjusting powers of the downlink signals.

10. The communication method according to claim 9,
wherein the adjusting powers of the downlink signals comprises:
comparing the indication information for beam correspondence with a preset threshold condition; and
adjusting the powers of the downlink signals until indication information for beam correspondence which satisfies the preset threshold condition is received, when the indication information for beam correspondence does not satisfy the preset threshold condition.

11. The communication method according to claim 10,
wherein the comparing the indication information for beam correspondence with the preset threshold condition comprises comparing the measurement result for the Reference Signal Receiving Power, the Reference Signal Receiving Quality, and the Signal-to-Noise Ratio of the downlink signals with a preset threshold condition for the Reference Signal Receiving Power, the Reference Signal Receiving Quality and the Signal-to-Noise Ratio,
wherein the adjusting powers of the downlink signals comprises performing power adjustment on one or more of a plurality of types of the downlink signals.

12. A user equipment, comprising:
a memory;
a transceiver; and
a processor coupled to the transceiver and the memory, wherein the processor is configured to:
measure downlink signals,
determine a downlink receiving beam and a first uplink transmitting beam according to a measurement result for the downlink signals,
generate indication information for beam correspondence according to the measurement result for at least one of the downlink signals and preset user equipment information,
send, to a network equipment, the generated indication information for beam correspondence with the determined first uplink transmitting beam,
perform uplink transmitting beam sweeping according to the resource for performing uplink transmitting beam sweeping allocated by the network equipment, when an indication to enable uplink transmitting beam sweeping of the user equipment sent by the network equipment is received,
receive, with the determined downlink receiving beam, the measurement result of the uplink transmitting beam sweeping fed back by the network equipment,
determine a second uplink transmitting beam according to the measurement result of the uplink transmitting beam sweeping; and
transmit an uplink signal with the determined second uplink transmitting beam.

13. A network equipment, comprising:
a memory;
a transceiver; and
a processor coupled to the transceiver and the memory, wherein the processor is configured to:
receive indication information for beam correspondence sent by a user equipment,
determine whether to enable uplink transmitting beam sweeping of the user equipment according to the received indication information for beam correspondence,
send an indication of whether to enable uplink transmitting beam sweeping of the user equipment to the user equipment,
allocate an uplink sounding reference signal resource to the user equipment according to the received indication information for beam correspondence, when it is determined to enable uplink transmitting beam sweeping of the user equipment,
measure the beams swept by the user equipment in the uplink transmitting beam sweeping, and
feed back the measurement result of the uplink transmitting beam sweeping to the user equipment.

14. The network equipment according to claim 13,
the processor further configured to:
perform power adjustment on one or more of a plurality of types of the downlink signals.

15. A computer-readable recording medium having recorded thereon instruction for performing claim 1.
